(19) United States
(12) Patent Application Publication
(10) Pub. No.: US 2012/0315808 A1
(43) Pub. Date: Dec. 13, 2012

(54) DUST CAP WITH DESICCANT

(75) Inventor: Michael Patrick Millard, Deerfield Beach, FL (US)

(73) Assignee: IZZY INDUSTRIES INC., Gilford, NH (US)

(21) Appl. No.: 13/359,872

(22) Filed: Jan. 27, 2012

Related U.S. Application Data
(60) Provisional application No. 61/520,297, filed on Jun. 8, 2011.

(51) Int. Cl. H01R 13/52

(52) U.S. Cl. 439/892

(57) ABSTRACT

Dust caps for cable connectors are provided. The dust caps include an internal reservoir containing a quantity of desiccant held captive by an air permeable stopper. The desiccant can be a color-indicating type, and can include a gas absorbing material. The dust cap can be threaded to mate with cable connectors and can be configured to connect to male or female threaded connectors. A gasket can be included to provide a substantially airtight seal when the dust cap is installed on a connector. The dust cap can be constructed of a transparent material to allow for visual inspection of the desiccant.

### RELATED APPLICATION

This application relates to and claims priority to U.S. Provisional Patent Application entitled “Dust Cap With Desiccant” filed Jun. 8, 2011 and assigned U.S. application Ser. No. 61/520,297, which is hereby herein incorporated by reference in its entirety for all purposes.

### BACKGROUND OF THE INVENTION

1. Field of the Disclosure

The present invention relates to protective dust caps and, more particularly, to a dust cap having a desiccant to absorb moisture and protect radiofrequency connectors from physical damage during initial installation or long-term storage.

2. Discussion of Related Art

The electrical and mechanical performance of radiofrequency connectors depends greatly upon the connector mating surfaces being free of all contaminants and excessive moisture. Contaminants, moisture, or foreign matter in contact with the mating surfaces can lead to acute or chronic performance degradation of the connection. Contaminants may result in unacceptably high levels of passive intermodulation noise being generated in the connectors, or prevent their proper mating to other connectors or equipment. Excessive moisture, or liquid, may change the characteristic impedance of the connection, causing an impedance mismatch, unacceptably high return loss, or high voltage standing wave ratio at the connector interface. Foreign matter in the connection may cause unacceptably high power losses in the system, or cause the connector to arc. Arcing connectors may cause the associated transmitter to shutdown in order to protect the power amplifier of the transmitter. Physical damage of the connector may result in excessive passive intermodulation noise, high return loss, or unacceptable radiofrequency system performance.

Many radiofrequency connectors are constructed by depositing silver or silver alloys on their mating surfaces. Frequently the electrical performance of silver contacts is impaired by the undesirable growth of a sulfide film on the mating contact surfaces. In the case where one or both of the mating surfaces are silver, or partly silver, and a silver sulfide film (Ag₂S) is formed on any of the connector mating surfaces, the electrical performance is greatly deteriorated and is among the most complex found on contaminated contacts. Physical damage in the form of abrasion or scratches of the radiofrequency connector mating surfaces will also degrade performance. Skin effect is the description given to the phenomenon where electromagnetic fields (and therefore the electromagnetic current) decay rapidly with depth inside a good conductor. Because radiofrequency connectors are often constructed from highly conductive metals such as silver or silver alloys, the resulting skin effect is very pronounced. Many modern wireless communications networks use frequencies up to at least 2 GHz. A radiofrequency connector operating at 2 GHz and constructed of a highly conductive material will confine the majority of the electromagnetic fields and current to a conductor depth of approximately 1.42 microns ( 1/1,000,000 of a meter). In other words, the vast majority of the electromagnetic energy is flowing on the very outermost skin of the conductor. Because the skin effect depth is exceedingly tiny at these frequencies, any physical damage to the connector mating surfaces in the form of scratches or abrasions must be avoided.

While some manufacturers choose to ship their connectors (or equipment having connectors) with dust caps, these dust caps are often flimsy and of a temporary nature intended solely to prevent large debris or other foreign matter from entering the connector during transit. They are not suitable to be left in place on the connector, or equipment, while actual installation is underway, and they will not protect the connector from the performance-degrading hazards mentioned above. Therefore, radiofrequency connectors remain extremely vulnerable to damage during the construction phase of telecommunications facilities, including cell sites on towers, flagpoles and rooftops. An installation crew may physically handle the connector dozens of times until it is finally placed into its permanent operating position and connected to other connectors or equipment. Often, the preparation of a wireless facility sites involves earthworks or other civil engineering preparations which typically create very dusty, dirty environments.

Furthermore, in some geographic areas, weather conditions may make it very difficult to keep connectors dry at all times. It should be noted that even after initial construction, improperly protected radiofrequency connectors might still be damaged as a result of ongoing maintenance activities.

Finally, any dust cap or other protective device or appliance that seeks to solve these problems must consider ease-of-use by the tower crew personnel who must install, or uninstall it. Tower crews working at altitude benefit greatly from having at least one hand free for other attentions. Furthermore, any solution should consider the time constraints of personnel working at altitude outdoors on a tower. For example, if inclement weather is threatening, installation crews must have sufficient advance notice to “seal everything up” before the rains come. Solutions should seek to minimize this time requirement, which, if fulfilled, provides many downstream benefits relating to overall project management and labor costs.

So in summary, radiofrequency connectors, and equipment using radiofrequency connectors, are highly susceptible to damage especially during the construction phase of telecommunication facilities. This damage results from the unavoidable handling of the connector, and is caused by the unintended introduction of foreign substances into the connector, including moisture, dirt, perspiration, body oils and debris. Connectors are also physically damaged by unintentional scratches or abrasions to the very thin outermost layer of the conductor, where the majority of the electromagnetic current is present. Passive intermodulation performance of scratched or abraded connectors is known to be quite poor.

There exist at least five other solutions to connector protection described in the prior art. Essentially these are:

1) “tape, or tape and butyl rubber wraps”,

2) “weatherproofing kits”,

3) “cold-shrink tubing”,

4) “specialized solutions”, and

5) “pressurized systems”.

### Tape, or Tape and Butyl Rubber Wraps:

“Tape, or tape and butyl rubber wraps” refers to a long-established industry practice of using a vinyl or plastic first wrap of tape applied to the connector to be protected, followed by an application of butyl rubber over the first wrap of tape, and then the application of a second outer wrap of vinyl or plastic tape. The innermost wrap of tape helps to keep the sticky butyl rubber off the connector. This tape “sandwich” is a proven reliable, universal approach to connector weatherproofing.

With regard to tape, or tape and butyl rubber wraps, the prior art describes approaches in which the tape's adhesive backing is allowed to come into direct contact with the radiofrequency connector's mating surfaces. This is undesirable since at least a portion of the adhesive can be expected to remain on the connector once the tape is removed and this residual adhesive may attract and collect dust, dirt and other debris.

Tape is expensive in the long term because it may only be applied once and is not reusable. Tape is also expensive in terms of the labor costs required for its proper application. It would not be unusual for an installer to spend several minutes applying or removing tape from a single radiofrequency connector. Furthermore, the time spent to apply or remove tape from a connector has the undesirable consequence of limiting on-site work activities since a large number of connectors cannot be worked with simultaneously. In other words, because it takes so long to perform, crews must stop activities well in advance of advancing inclement weather in order to seal up all the connectors. A typical cell site may have several dozen such connectors requiring protection while the site is being constructed. On a day where drizzly rain occurs at frequent intervals throughout the day, the installation crew can be expected to do little more than wrap and unwrap taped connectors. One of the many reasons it takes so long to install tape is that a tower climber must safely reposition himself on the tower and strap himself in for each connector to be worked.

Tape does not allow one-handed application, and this inconvenience contributes to the overall cost of using this approach to protect connectors.

Tape seals in any moisture that might already be present in the connector. Assuming the tape and butyl rubber is applied correctly, there is no chance for any moisture already present in the connector to escape, or be absorbed by the tape and butyl rubber applied.

Tape provides no visible means to determine whether moisture or other contaminants are present in the connector once applied. In fact, once the tape and butyl “sandwich” wrap is applied, the connector interface is not visible.

Also, once tape and butyl is applied, the Protected Connector cannot be tightened, loosened, or adjusted without first removing the tape and butyl rubber wrap protection.

Tape and butyl rubber wrap systems are very heavy compared to other solutions, and can easily fatigue a tower climber who must transport them significant vertical distances up a tower. Additionally, the mass and weight of a typical kit of butyl rubber can be up to several pounds and may constitute a deadly projectile if accidentally dropped by a tower climber while he is at altitude on a tower.

Tape and butyl rubber wrap systems are extremely difficult to apply to connectors which have limited access in-situ. The time and effort required to apply a tape and butyl rubber wrap protection to connectors located in awkward or otherwise confined or limited-access locations increases dramatically. A full 360-degree range of motion extending out several inches from the connector is desirable in order to apply a tape and butyl rubber wrap. Such range of motion is often not available where many connectors require protection in a very limited amount of space.

Finally, a tape and butyl wrap approach is not a one-piece solution. If an installer should exhaust his supply of either tape or butyl rubber, work activity must necessarily stop until her supplies can be replenished. This situation is particularly troublesome should it occur while the installer is at altitude on the tower, since there may be no easy means to transport supplies to the work location without having to physically reposition oneself on the tower, and strap in for fall protection safety. Alternatively, if no tagline is present, one of the workers must descend to ground level to pick up additional supplies and then re-climb the tower, possibly fatiguing the worker.

### Weatherproofing Kits:

“Weatherproofing Kits” refer to devices that are intended to completely surround the connector with a plastic, gasketed housing. With regard to weatherproofing kits, these too are expensive both in terms of material and labor costs. The weatherproofing kits themselves are very expensive as compared with all other solutions, although they are reusable. Labor costs are slightly elevated due in part to the fact that the weatherproofing kits may only be installed on straight sections of transmission line. Curved sections of transmission line will require straightening prior to installation. Labor costs are also elevated because the weatherproofing kits requires both hands for installation and therefore requires the tower crew installer to be fully strapped into the tower for fall protection safety reasons.

Like tape and butyl systems, weatherproofing kits have the disadvantage of sealing-in any moisture which might be present at the time the weatherproofing kit is applied. Because the weatherproofing kit is completely sealed on all sides, there is no possibility for trapped moisture to escape or be absorbed by the weatherproofing kit itself. Any moisture present will remain locked inside the weatherproofing kit until the kit is removed. Weatherproofing kits provide no visible indication of any moisture that may be trapped within the protected space. Also, because the weatherproofing kits are manufactured using opaque materials, no visible indication of contaminants within the protected space is possible.

A further shortcoming of weatherproofing kits is they have many moving parts, which may break over time.

### Cold-Shrink Tubing:

“Cold-shrink tubing” refers to devices that are intended to completely surround the connector with a collapsible layer of foam rubber. The foam rubber is initially supplied by its manufacturer as a foam rubber cylinder, open at each end, stretched over a segmented plastic core that can be collapsed by pulling a tap on one end of the core. This pulling action unwinds the perforated spiral wrap construction of the core and allows the foam rubber to “shrink” tightly around the connector requiring protection as the core is effectively unwound and removed.

With regard to cold shrink tubing solutions, these too are very expensive when compared to other approaches. Cold shrink tubing is not reusable. While initial installation is quick and easy, its removal involves physically cutting it from the protected connector and this cutting action places both the connector and associated transmission line, if any, at an elevated risk of damage. It should be noted that replacement transmission line would typically result in financial losses of many thousands of dollars, with a commensurate delay in work activities while replacement transmission line can be ordered and transported to the job site.

Another factor affecting the overall labor cost of using cold shrink tubing is that its application requires the use of both hands; one to hold the tube, and the other to pull and separate the perforated inner plastic core. The requirement to have both hands free requires the installer to be safety secured onto the tower structural members and this constant repositioning of the worker consumes copious amounts of time.

Cold shrink tubing cannot be used in situations involving the temporary protection of connectors that are not already attached to their final installed position. In other words, cold shrink tubing will always have an open “end”, and therefore, cannot be used to protect individual connectors.

As with other solutions, the use of cold shrink tubing seals in any moisture that was present at the time it was applied. Because cold shrink tubing is opaque, it provides no visible indication of any moisture that may be trapped in the connector's protected space. Also, because cold shrink tubing is opaque, no visible indication of contaminants within the protected space is possible.

Cold shrink tubing has the additional disadvantage of requiring advance preparation of the workpiece to be protected. The use of cold shrink tubing requires that the plastic perforated core holding the cold shrink tubing in its uncollapsed state be capable of sliding into position once the connection in made. The connector is tightened to appropriate torque specifications, the core is slid into position, and the perforated core retracted. It is not possible to apply cold shrink tubing to connections unless not previously prepared in the manner described above unless at least one end is free to accept the uncollapsed core. Once applied, the connector cannot be tightened further without risk of damaging the cold shrink tubing.

A further drawback to cold shrink tubing is that it is not supplied in a universal size. Cold shrink tubing only collapses to a specified diameter, and the plastic perforated cored must be physically large enough to slide over the connector to be protected (as well as any transmission line or other equipment connected thereto). As a result, many difference sizes of cold shrink tubing may be required to complete a given job.

A further drawback to cold shrink tubing is that it is bulky when compared to other solutions. This bulk limits the amount of space available in a climbing bag, or tool bag, which the tower climber may use to transport materials to the work elevation on a communications tower. The requirement to carry a second climbing bag or tool bag may limit tower climber mobility on the tower or contribute to climber fatigue.

### Specialized Solutions:

“Specialized solutions” refers to manufacturer-specific approaches to connector protection. Manufacturer-specific solutions are quite expensive, owing to their proprietary nature and general inapplicability to connectors and transmission line made by others. As a consequence, there is little economy of scale in their manufacture, and they remain a niche solution to connector protection. In the example cited (PPC), the solution involves a complicated, multiple component approach that requires additional personnel training to install properly. Specialized tools are required, and these tools may not always be available to a tower crewmember working at altitude on a tower structure. At the very least, the tower climber may expect the requirement to carry additional heavy tools (along with his other work materials and safety equipment), and this extra weight may fatigue the worker. Furthermore, because the tools involve cutting, they are intended for use on a stable platform that may not be available at altitude on a communications tower. Both the specialized solution and the required installation tools require the use of both hands, thereby further limiting movement and flexibility of the worker on the tower.

In view of the above, it can be expected that labor costs are high when compared to other solutions. As with tape, significant advance notice is required if weather threatens and many connectors are “open”. Much time can be wasted preparing for a storm that will never come, but because of the time involved to implement the specialized solution, workers have little choice but to start early—time that could be better spent attending to other duties.

Like many of the other solutions mentioned, specialized solutions also seal in any moisture that was present at the moment it was applied. There is no provision for any trapped moisture to escape, and there are no provisions present to facilitate a visible inspection of the connector for moisture or contaminants once the specialized solution has been applied.

Specialized solutions cannot be used on “open” connectors, meaning they cannot be used unless the connector to be protected is actually connected to something. Therefore, the use of specialized solutions requires at least some preparation in order to use, even if that preparation is temporarily attaching some other device or connector to the connector to be protected. Finally, specialized solutions are not a “one-size-fits-all” approach, and that fact necessitates the stocking of many different sizes at the jobsite.

### Pressurized Systems:

“Pressurized systems” refers to situations in which the device to be protected is pressurized to a positive atmosphere of air, nitrogen gas (N₂), dry nitrogen gas (N₂), sulfur hexafluoride (SF₆) or other suitable gas. The pressurized gas acts as a positive pressure moisture barrier. In practice, such pressurized systems are typically used only on larger, high-power, AM, FM, Short-wave, Medium wave, satellite uplink, and television broadcast station installations, though they do find rare use in more traditional land-mobile, two-way radio type facilities.

Some connectors used on these higher power systems allow pressurized gas to contact the mating surfaces of the connector, but often, the connectors are supplied with a gas barrier, which leaves the mating surfaces unprotected.

It must be realized that radiofrequency connectors intended for indoor use are, in general, not suitable candidates for the above five described solutions for various reasons, many of which are outlined in the following section regarding shortcomings of the prior art. However, connectors intended for indoor deployment are still susceptible to damage caused by physical abuse, contaminants, moisture (rain excepted, generally), abrasion and scratches and would benefit from the protections this invention provides.

Pressurized solutions are generally very expensive compared with other approaches, particularly in the case of land-mobile, two-way radio, or cellular radiotelephone facility installations where many such radiofrequency connectors must be protected. Additionally, land- mobile, two-way, cellular and similar facilities do not typically use air dielectric transmission line, which militates against the use of pressurized systems. The use of foam dielectric transmission lines necessitates the installation of separate pressure lines to each connector, and this is impractical where many such connectors require protection.

Another shortcoming of pressurized solutions is that they cannot protect the mating surfaces of radiofrequency connectors if those surfaces do not have an unobstructed airway path to the source of pressurization. Many non-broadcast type connectors are not designed to allow the pressurized gas to contact the connector surfaces, and thus, could not benefit from a pressurized solution to connector protection.

A further drawback of pressurized systems is that they can seal moisture in. Some pressurized solutions use a small horsepower motor to periodically forcibly exchange the air volume contained within the air dielectric transmission line and air permeable connector interfaces. In some larger system, this forced air may be dried using a desiccant canister attached to the ground-based pressurization system.

Furthermore, pressurized systems are only capable of protecting those types of transmission lines and radiofrequency connectors that are constructed with an integral gas permeable separator, for example, “bullets” in a long run of rigid coaxial transmission line. A “bullet” is the connector used to connect two sections of rigid transmission line together.

A further shortcoming of pressurized systems is that they tend to develop air leaks over time, resulting in an on-going requirement to maintain and repair the system, or resulting in the need to constantly change out emptied gas cylinders for replacement pressurized cylinders. Either of these outcomes is an added ongoing operational expense, particularly if the leak occurs at altitude on the tower, requiring a redeployment of the tower crew.

A further drawback of pressurized systems is that the transmission line components they are design to protect must already be installed, before such a system can be connected. Therefore, pressurized systems can offer no protection during the initial construction phases, when radiofrequency connectors are most vulnerable to damage, abuse, moisture intrusion, foreign matter intrusion, abrasion and scratching.

A further drawback of pressurized systems is that their use requires highly specialized safety training that conforms to the requirements of OSHA (the Occupational Safety and Health Act of 1970), or other worker safety programs. There exist numerous recognized hazards associated with the handling and use of compressed gas cylinders and therefore, personnel who lack the proper training may not install pressurized systems.

### OBJECTS OF THE INVENTION

It is therefore an object of the invention to provide a convenient way to temporarily protect radiofrequency connectors, particularly during the initial construction phases of wireless telecommunications facilities, or during long-term storage.

It is another object of the invention to protect radiofrequency connectors from physical damage caused by handling, mishandling and unintentional abuse.

It is another object of the invention to protect radiofrequency connectors from the harmful effects of moisture or moisture accumulation.

It is another object of the invention to protect radiofrequency connectors from the harmful effects of an accumulation of silver sulfide (Ag₂S), better known as silver tarnish, on the mating surfaces of the radiofrequency connector.

It is another object of the invention to provide a convenient way to visually inspect the saturation level of the moisture-absorbing desiccant without having to remove the invention from the connector or device is it protecting.

It is another object of the invention to provide a convenient way to permanently protect radiofrequency connectors, and devices utilizing radiofrequency connectors, particularly while in transit, storage, long-term storage and during long periods when not otherwise in active use.

It is another object of the invention to provide a dust cap that can be installed with one hand, without the use of tools or the requirement for specialized training.

It is another object of the invention to provide a dust cap, in one or more industry trade sizes, for radiofrequency connectors and other equipment, such that they can be fitted, or mated, to any manufacturers' connector, device or other article whose connector(s) conform to industry trade sizes.

It is another object of the invention to provide a dust cap that is lightweight, and will not fatigue tower climbing personnel who may be required to transport the invention in significant quantities to high altitudes above ground, such as on a communications tower.

It is another object of the invention to provide an integrated, one-piece design solution. It is another object of the invention to allow a protected radiofrequency connector to be inspected, tightened, loosened or otherwise adjusted, while the dust cap is attached.

It is another object of the invention to provide an inexpensive alternative to existing products that attempt to protect radiofrequency connectors from moisture, foreign matter ingress, tarnish, contaminants, body oils, scratches or abrasions.

It is another object of the invention to allow a rapid installation of the dust cap on a radiofrequency connector to be protected.

It is another object of the invention to allow its use on a single-ended transmission line, or single-port device (i.e., one having only a single connector to be protected), without the requirement that the loose end connector be attached to any other item other than the dust cap.

It is another object of the invention to allow its use without any special preparation of the connector or device to which it will be attached.

It is another object of the invention to prevent sealing-in moisture by providing a desiccant to absorb any moisture which might be present.

It is another object of the invention to be operable in any orientation.

It is another object of the invention to be operable at high altitude, at sea level, at altitudes typically encountered for wireless telecommunications or broadcast radio & television towers, or submerged up to several atmospheres of pressure.

It is another object of the invention to be operable under driving rain, or high-pressure external water streams or salt spray, such as may occur during hurricanes, tropical storms, or gale force winds.

It is another object of the invention to be constructed of high-impact materials, suitable for use in construction zones or other areas where the invention may be subject to strong physical impacts without breaking, cracking, chipping or deforming

### BRIEF SUMMARY OF THE INVENTION

One aspect of the invention is directed to a dust cap having an internal reservoir containing a quantity of desiccant held captive by an air permeable stopper is provided. The desiccant is intended to reduce and/or remove any moisture that is present in the connector. The desiccant is optionally a color-indicating type, although non-color-indicating desiccants, or a mixture of color and non-color-indicating desiccants may also be used.

Radiofrequency connector performance can be greatly degraded by the presence of moisture, foreign objects, or contaminants. Additionally, the formation of silver sulfide (chemical name Ag₂S, or more commonly “tarnish”) is known to be accelerated in high humidity environments. The presence of the desiccant lowers the relative humidity and thereby prevents the accumulation of tarnish on the connector. The desiccant may also include a quantity of a gas absorbing material, for example, activated charcoal, which has been shown to directly absorb sulfur dioxide and other gases that may contribute to the formation of silver sulfide on the mating surfaces of the connector.

The dust cap is available in various sizes and design styles having threads, dimensions, and desiccant quantities suitable to mate with any one of several common trade sizes for radiofrequency connectors, such as type-N, 7/16 DIN, LC, EIA Flange sizes, and similar types of connectors. For common trade size connectors available in more than a single thread style, (for example, a 7/16 DIN connector is available in both a male and female threaded version), the dust cap is available in both sexes with each sex having the appropriate male or female threading.

Another aspect of the invention is directed to a cable connector protective device. The protective device includes a body having an interior defining a reservoir, the reservoir containing desiccant material. The body further includes an open end. An air permeable barrier resides between the desiccant material and the open end of the body.

Another aspect of the invention is directed to a dust cap for protecting a cable connector. The dust cap includes a body defining an internal reservoir having an open end, desiccant contained within the internal reservoir, and an air permeable stopper between the desiccant and the open end of the body.

Yet another aspect of the invention is directed to the combination of a cable connector and a protective device. The combination includes a cable connector, such as, for example, a radiofrequency connector, having a connector mating surface. A protective device comprises a body having an interior defining a reservoir and an open end, the reservoir of the body containing desiccant material, and an air permeable barrier between the desiccant material and the open end of the body. The protective device is removably secured to the cable connector. In some embodiments, the protective device forms a substantially air-tight seal when the protective device is secured to the cable connector. In some embodiments, the cable connector comprises threads and the protective device comprises threads configured to engage the threads of the cable connector. In some embodiments, the body of the protective device is removably secured to the threads of the connection device.

In certain embodiments of any of the aspects of the invention, the body comprises a cylinder, which can in some embodiments be no more than about 1.5 inches in diameter. The body can in some embodiments include threads at the open end of the body, for mating with threads of a cable connector. The threads can in some embodiments be either male or female threads. The body can in some embodiments be removable from the threads.

The desiccant material in some embodiments comprises at least one of silica gel, calcium sulfate, calcium chloride, molecular sieve, and clay, and can optionally include a gas absorbing material such as, for example, activated charcoal. The desiccant material in some embodiments comprises a material that is one color when dry and a different color when moist, such as, for example, cobalt (III) chloride and/or methyl violet. In some embodiments, the reservoir has a volume no greater than about 1 cubic inch. In some embodiments, the reservoir contains no more than about 3 grams of desiccant material. The air permeable barrier in some embodiments comprises at least one of cotton, UV-stabilized foam, and perforated plastic. In some embodiments, the desiccant material is entirely contained within the air permeable barrier, so that, for example, the air permeable barrier containing the desiccant material can be removed from the reservoir and replaced with fresh desiccant material or heated to drive absorbed moisture out of the desiccant material, recharging the desiccant material.

The body in some embodiments comprises an optically transparent material, for example, at least one of polymethyl methacrylate polymer, polycarbonate, and glass. The body can in some embodiments include one or more transparent viewports through which the reservoir can be seen.

The protective device of claim in some embodiments includes a gasket that abuts a gasket shelf on the body. For example, where the body includes threads having an open-facing end and a reservoir-facing end and the threads face an exterior of the cylinder (i.e., male threads), the gasket shelf can be located on the exterior of the body adjacent the reservoir-facing end of the threads. Similarly, where the body includes threads having an open-facing end and a reservoir-facing end and the threads face an interior of the cylinder, (i.e. female threads), the gasket shelf can be located on the interior of the body adjacent the reservoir-facing end of the threads.

In some embodiments, the body of the protective device includes an air pressurization nozzle.

Still other aspects, embodiments, and advantages of these exemplary aspects and embodiments, are discussed in detail below. Embodiments disclosed herein may be combined with other embodiments in any manner consistent with at least one of the principles disclosed herein, and references to “an embodiment,” “some embodiments,” “an alternate embodiment,” “various embodiments,” “one embodiment” or the like are not necessarily mutually exclusive and are intended to indicate that a particular feature, structure, or characteristic described may be included in at least one embodiment. The appearances of such terms herein are not necessarily all referring to the same embodiment.

### BRIEF DESCRIPTION OF THE DRAWINGS

Various aspects of at least one embodiment are discussed below with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description or any claim are followed by references signs, the reference signs have been included for the sole purpose of increasing the intelligibility of the figures and description. In the figures, each identical or nearly identical component that is illustrated in various figures is represented by a like numeral. For purposes of clarity, not every component may be labeled in every figure. In the figures:

FIG. 1 is a cross sectional view of a male dust cap having a desiccant reservoir and air permeable barrier;

FIG. 2 is a cross sectional view of a female dust cap having a desiccant reservoir and air permeable barrier; and

FIG. 3 is a bottom view of a dust cap.

### DETAILED DESCRIPTION OF THE INVENTION

For the purposes of illustration only, and not to limit the generality, the invention will now be described in detail with reference to the accompanying figures. This invention is not limited in its application to the details of construction and the arrangement of components set forth in the following description or illustrated in the drawings. The invention is capable of other embodiments and of being practiced or being carried out in various ways. Also the phraseology and terminology used herein is for the purpose of description and should not be regarded as limiting. Any references to embodiments or elements or acts of the systems and methods herein referred to in the singular may also embrace embodiments including a plurality of these elements, and any references in plural to any embodiment or element or act herein may also embrace embodiments including only a single element. The use of “including,” “comprising,” “having,” “containing,” “involving,” and variations thereof herein, is meant to encompass the items listed thereafter and equivalents thereof as well as additional items. References to “or” may be construed as inclusive so that any terms described using “or” may indicate any of a single, more than one, and all of the described terms.

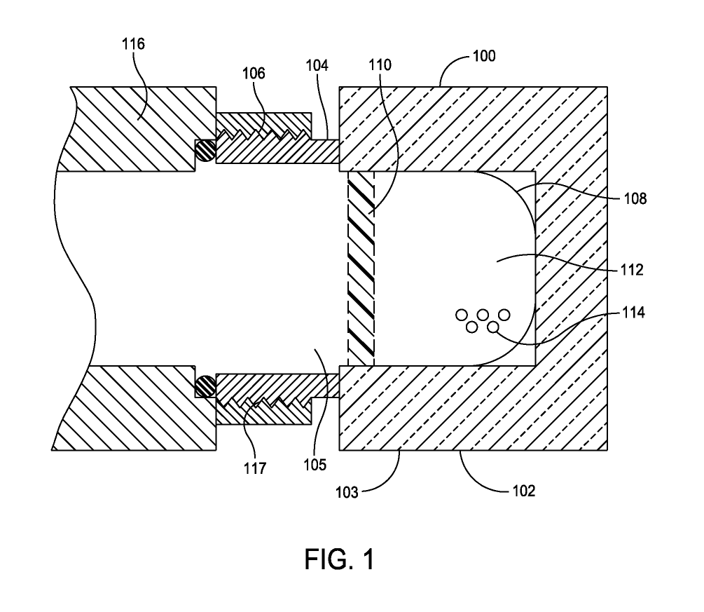

FIG. 1 is a cross sectional view of a male threaded dust cap, otherwise referred to as a male dust cap 100. The male dust dap 100, as shown, approximates a cylinder 1.5″ long by 1.5″ in diameter. The male dust cap 100 includes a transparent body 102 having an exterior 103 and an open end 105. A stub 104 that contains the male threads 106 extends from the open end 105 of the body 102. The male threads 106 are configured to mate with threads 117 on a cable connector 116.

The body 102 defines a reservoir 112, which may include an optional inside radius 108 cut at the end opposite the open end 105 of the body 102. The provision of the inside radius 108 may facilitate in the manufacture of the body 102. Desiccant material 114 is held captive within the reservoir 112 by an air permeable barrier 110.

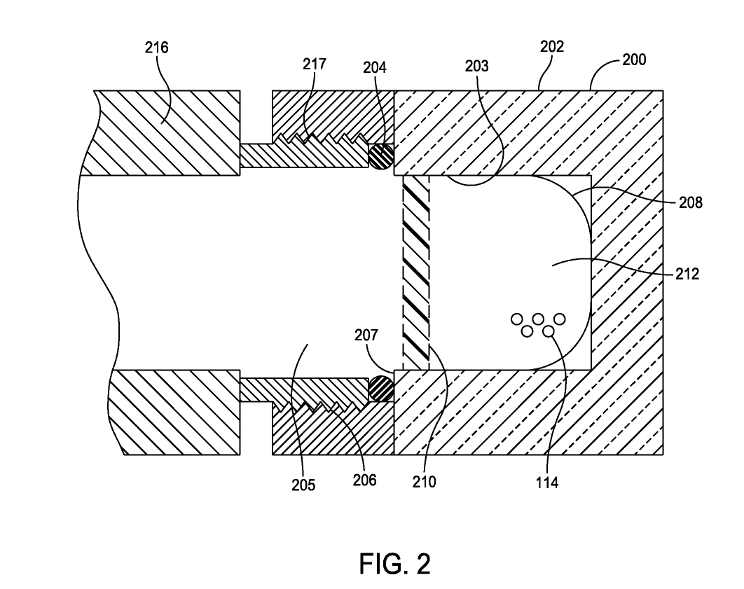

FIG. 2 is a cross sectional view of a female threaded dust cap 200, otherwise referred to as a female dust cap. The female dust cap 200, as shown, approximates a cylinder 1.5″ long by 1.5″ in diameter. The female dust cap 200 includes a transparent body 202 having an interior 203 and an open end 205. Female threads 206 are located in open end 205 of the body 202, with the threads facing the interior 203 of the body 202. The female threads 206 are configured to mate with threads 217 on a cable connector 216.

The female dust cap 200 includes a reservoir 212, which may include an optional inside radius 208 cut at the end opposite the open end 205 of the body 202. The provision of the inside radius 208 may facilitate in the manufacture of the body 202. Desiccant material 114 is held captive within the reservoir 212 by an air permeable barrier 210.

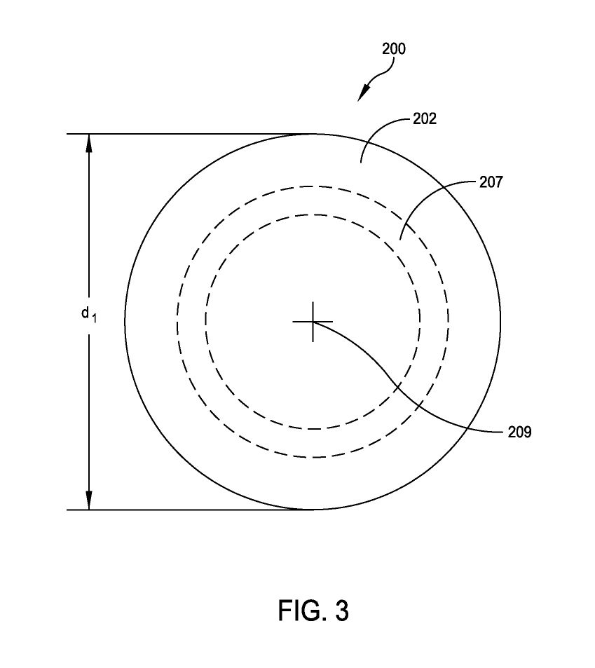

FIG. 3 is a bottom view of the female dust cap 200, showing the approximate location and dimensions of a gasket shelf 207 relative to a centerline 209.

The embodiments illustrated in FIGS. 1 and 2 illustrate male and female 7/16 DIN connectors that are commonly used in the wireless telecommunications industry. It is to be understood that the only substantial difference between the male dust cap 100 and the female dust cap 200 described herein is the type of threads that each contains. The male dust cap 100 is intended to mate with the cable connector 116 having female threads, and the female dust cap 200 is intended to mate with the cable connector 216 having male threads. Some connectors are unisex and are not supplied in separate male and female versions.

In this section, the male dust cap 100 will be described in greater detail. Except as noted, it is to be understood that the concepts described herein are applicable to the female dust cap 200.

The body 102 of the male dust cap 100 can be constructed of a transparent material suitable for long-term outdoor use. In some embodiments, the body 102 is constructed of polymethyl methacrylate (“PMMA” or “acrylic”) transparent polymer, transparent polycarbonate, or glass. Other materials having the combined properties of transparency and long-term resistance to UV exposure may also be employed.

Transparency of the body 102 of the male dust cap 100 allows a user to visually inspect for the presence of foreign objects or other contaminants, and optionally to visually inspect the saturation level of a color-indicating desiccant material contained within the reservoir 112 where one is employed (as discussed in greater detail below). Where the body 102 is constructed from polymers such as acrylic or polycarbonate, standard plastics manufacturing techniques may be used. These standard techniques include computer-numeric-controlled (CNC) drilling, injection molding, blow-molding, and other suitable manufacturing techniques known in the art of plastics manufacturing. The body 102 may also be fabricated of glass.

In some embodiments of the invention, the body of the dust cap may be constructed of opaque materials, such as opaque PVC or other opaque or translucent engineered plastics. Optionally, the body of such embodiments may include one or more transparent viewports with which to view the interior of the cap. Such a viewport can in some embodiments be constructed of polymethyl methacrylate transparent polymer, transparent polycarbonate, or glass.

In some embodiments of the invention, the dust cap may be constructed as a two-piece device, with the body defining the reservoir modified such that it is detachable from the remainder of the dust cap. In some such embodiments, the non-detachable portions of the dust cap may be constructed of any one or more of several materials, including plastic, acrylic, polycarbonate, PVC, carbon fiber, glass, or any other suitable material. This design may permit the desiccant material to be replaced and/or allow moisture in the desiccant material to be driven off as by, for example, heating, without having to remove the remainder of the dust cap from the cable connector to which it is attached.

Certain embodiments of the dust cap are designed to be quickly and easily installed and removed without the use of hand or power tools and without the requirement for specialized training of personnel. Certain embodiments of the dust cap are designed for long-term outdoor use, in all weather conditions, as well as for use in indoor environments.

In some embodiments, the dust cap is provided with a removable air-permeable barrier that allows the desiccant material to be removed and recharged, or replaced. The air permeable barrier is in some embodiments made of a UV-stabilized material such as cotton, UV-stabilized foam, perforated plastic, or other suitable material. The perforations, if any, are large enough to allow air to freely pass between the connector interface being protected and the desiccant material, but small enough to contain the desiccant material within the reservoir of the body of the dust cap. In this fashion, the dust cap may prevent the spilling of desiccant material, permitting the dust cap to be operable in any orientation. The dust caps in some embodiments are designed to be operable whether deployed at high altitude, at sea level, at heights typically encountered for wireless telecommunications or broadcast radio & television towers, or submerged up to several atmospheres of pressure.

In some embodiments, the desiccant material comprises silica gel, although calcium sulfate (CaSO4), calcium chloride or other desiccant materials may be used. Molecular sieves, clay, or other moisture-absorbing materials may also be employed as desiccant material.

Many desiccants, for example, silica-gel type desiccants, may be recharged by heating them, for example, for a period typically not exceeding several hours in an oven set to an appropriate temperature. This process causes the desiccant material to release moisture it has previously absorbed and returns the desiccant material towards its unsaturated, anhydrous state. Most silica-gel type desiccant materials may be recharged in this manner for the lifetime of the dust cap.

In some embodiments, a color-indicating desiccant material is employed. Such desiccant materials typically exhibit a first color when in a first, substantially anhydrous state and a second color when in a second, hydrated state. For example, silica gel desiccant material can be provided in bead form and can be doped with a moisture indicator such as cobalt(II) chloride, which is deep blue when dry or anhydrous and bright pink when moist or hydrated. Blue-to-pink indicating silica gels offer the most easily observable color contrast of all commercially inexpensive color indicating silica gels and are preferred for use in tower environments where personnel safety is a primary consideration. In some jurisdictions, cobalt(II) chloride is considered to be hazardous to human health. Therefore, in some embodiments, the amount of desiccant material used in each dust cap is kept small, with a resulting miniscule total amount of cobalt(II) chloride present. Alternatively, the dust cap can be provided using desiccant materials having non-toxic doping agents, such as methyl violet, which results in an “orange-to-green” indicating type of silica gel. In the case of methyl violet silica gels, the silica gel beads are orange when dry and green when hydrated. Other silica gels may use different chemistry in their color-indicating functionality.

It is highly desirable to be able to view the hydration status of the desiccant material from a great distance, with the dust cap held in practically any orientation, instead of being forced to reposition oneself on the tower and thereby increase the risk of injury or fatality due to falling. Therefore, in some embodiments, the dust caps have an optically transparent body which allows a visual inspection of the desiccant material's hydration status (e.g., the desiccant material's color). This optically clear body also allows for the visual inspection for foreign matter or other contaminants.

In some embodiments, the dust cap is kept small enough to fit in one's hand, and be installable and removable using only one hand. The small mass is desirable because a typical communications tower may require a large quantity of dust caps to be carried by tower personnel as they ascend the tower. It is highly desirable to keep the total climbing weight to a minimum so as not to fatigue the tower climber. For example, in some embodiments, when provided as an acrylic, male-type, 7/16 DIN male dust cap, the dust cap will approximate a mostly hollow cylinder, open at one end, measuring approximately 1.5 inches in length by 1.5 inches in diameter and weighing approximately 38 grams (1.34 ounces) when filled with approximately 3 grams of dry desiccant material.

Some embodiments (such as the dust cap 200 illustrated in FIG. 3) will have a maximum outer diameter d1 of approximately 38 millimeters (1.5 inches) so that several dust caps 200 may be attached to certain types of equipment without running into or colliding into each other. For example, the Kathrein antenna model 80010675, commonly used in telecommunication facilities construction, has a minimum connector-to-connector spacing of only 43.9 millimeters. If the diameter of a male dust cap were larger than half this distance, it would not be possible to install a dust cap onto every connector (port) of the Kathrein antenna described above, because the dust caps would overlap each other in physical space.

In accordance with the desire to maintain a small overall size and weight of the dust cap, certain embodiments provide a small volume reservoir. This reservoir may be sized to house a sufficient quantity of desiccant material necessary to adequately protect the enclosed air volume of the connector and dust cap assembly. In some embodiments, this air volume is about 1 cubic inch or less, and contains less than about 3 grams (for example, less than about 2 grams) of desiccant material to provide adequate long-term protection. The amount of desiccant material which may be required for larger connectors, such as EIA Flanges, is readily calculated by formulae known in the art. In cases where larger amounts of desiccant material are required to adequately protect the cable connector, the reservoir and amount of desiccant material are sized appropriately.

In some embodiments, a gasket is included on the dust cap to permit the formation of a substantially air-tight seal with a cable connector when the dust cap is installed on a cable connector. For example, referring back to FIG. 2, the female dust cap 200 includes a gasket or o-ring 204. The gasket 204 abuts, resides on and/or is affixed to a gasket shelf 207 located on the interior of the body adjacent to the reservoir-facing end of the threads. The gasket shelf 207 is in some embodiments a flat surface surrounding the opening of the reservoir 212 and is intended to provide a suitable sealing surface upon which the gasket 204 will seal. Alternatively, the gasket shelf 207 may be constructed in other forms, such as convex or concave, or any suitable surface against which the gasket 204 may compress and seal.

The gasket 204 can provide an airtight seal when the female dust cap 200 is mated with its opposite sex connector 216. Some cable connectors themselves have a gasket for this purpose, in which case the dust cap need not include a gasket even where an air-tight seal is desired. For example, 7/16 DIN male cable connectors already have a gasket built-in, and therefore, a corresponding female dust cap need not be equipped with a gasket. This gasket or o-ring is intended to be affixed to a gasket shelf, which is a preferably flat surface surrounding the opening of the desiccant reservoir and is intended to provide a suitable sealing surface upon which the gasket or o-ring will seal. The gasket or o-ring in some embodiments contains only a very limited quantity of sulfur-containing compounds to further limit the production of sulfide containing gases or vapors which might then aid the formation of tarnish on the connector mating surfaces.

In some embodiments, the gasket 204 is fabricated of nitrile rubber. Alternatively, the gasket 204 may be acceptably fabricated using neoprene rubber or other compressible, seal- forming materials. In some embodiments, the connector-facing inside diameter of the gasket is kept as small as possible in order to limit the total amount of sulfur-containing substances, to lower the risk of silver tarnish formation, although it should be understood that silver tarnish formation is slowed considerably in low humidity environments even when sulfur-containing materials are maintained in close proximity It should be noted that not all varieties of radiofrequency connectors contain internal gaskets or o-rings, and in such cases, embodiments the present invention can provide one.

Dust caps can be made in various sizes and design styles having threads, dimensions, and desiccant material quantities suitable to mate with any one of several common industry trade sizes for radiofrequency connectors, such as type-N, 7/16 DIN, LC, EIA Flange sizes, and similar types of connectors.

For common trade size connectors available in more than a single thread type, (for example, a 7/16 DIN connector is available in both a male and female threaded version), dust caps can be made in both sexes, with each sex having the appropriate male or female threading. Finally, in yet other embodiments, the dust cap may be further equipped with an air pressurization nozzle, such as, for example, a Schrader Valve (commonly known as an “American Valve”), Presta Valve, or other pneumatic inflation valve such that the invention may be pressurized after installation. An amount of positive pressurization applied may further serve to reduce moisture intrusion into the invention.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A cable connector protective device comprising:
a body having an interior defining a reservoir and an open end, the reservoir of the body containing desiccant material; and
an air permeable barrier between the desiccant material and the open end of the body.

2. The cable connector protective device of claim 1, wherein the body comprises a cylinder.

3. The cable connector protective device of claim 2, wherein the cylinder is about 1.5 inches in diameter.

4. The cable connector protective device of claim 3, wherein the body is removable from the threads.

5. The cable connector protective device of claim 1, comprising threads at the open end of the body.

6. The cable connector protective device of claim 1, wherein the desiccant material comprises at least one of silica gel, calcium sulfate, calcium chloride, molecular sieve, and clay.

7. The cable connector protective device of claim 1, wherein the desiccant material includes a gas absorbing material.

8. The cable connector protective device of claim 1, wherein the desiccant material comprises a material that is one color when dry and a different color when moist.

9. The cable connector protective device of claim 8, wherein the desiccant material comprises at least one of cobalt (III) chloride and methyl violet.

10. The cable connector protective device of claim 1, wherein the reservoir has a volume no greater than about 1 cubic inch.

11. The cable connector protective device of claim 1, wherein the reservoir contains no more than about 3 grams of desiccant material.

12. The cable connector protective device of claim 1, wherein the body comprises an optically transparent material.

13. The cable connector protective device of claim 12, wherein the body includes one or more transparent viewports through which the reservoir can be seen.

14. The cable connector protective device of claim 13, wherein the optically transparent material comprises at least one of polymethyl methacrylate polymer, polycarbonate, and glass.

15. The cable connector protective device of claim 1, wherein the air permeable barrier comprises at least one of cotton, UV-stabilized foam, and perforated plastic.

16. The cable connector protective device of claim 1, further comprising a gasket, the gasket abutting a gasket shelf on the body.

17. The cable connector protective device of claim 16, wherein the body comprises threads at the open end of the cylinder, the threads having an open-facing end and a reservoir-facing end, the threads facing an exterior of the cylinder, wherein the gasket shelf is located on the exterior of the body adjacent the reservoir-facing end of the threads.

18. The cable connector protective device of claim 16, wherein the body comprises threads at the open end of the cylinder, the threads having an open-facing end and a reservoir- facing end, the threads facing an interior of the cylinder, wherein the gasket shelf is located on the interior of the body adjacent the reservoir-facing end of the threads.

19. The cable connector protective device of claim 1, wherein the body includes an air pressurization nozzle.

20. A dust cap for protecting a cable connector, the dust cap comprising a body defining an internal reservoir having an open end, desiccant contained within the internal reservoir, and an air permeable stopper between the desiccant and the open end of the body.

21. A cable connector having a protective device, comprising
a cable connector comprising a connector mating surface, and
a protective device comprising a body having an interior defining a reservoir and an open end, the reservoir of the body containing desiccant material, and an air permeable barrier between the desiccant material and the open end of the body,
wherein the protective device is removably secured to the cable connector.

22. The cable connector having a protective device of claim 21, wherein the protective device forms a substantially air-tight seal about the connector mating surface when the protective device is secured to the cable connector.

23. The cable connector having a protective device of claim 21, wherein the cable connector comprises threads and the protective device comprises threads configured to engage the threads of the cable connector.

24. The cable connector of claim 23, wherein the body of the protective device is removably secured to the threads of the connection device.
